(19) United States
(12) Patent Application Publication
(10) Pub. No.: US 2022/0207258 A1
(43) Pub. Date: Jun. 30, 2022

(54) IMAGE IDENTIFICATION METHODS AND APPARATUSES, IMAGE GENERATION METHODS AND APPARATUSES, AND NEURAL NETWORK TRAINING METHODS AND APPARATUSES

(71) Applicant: SENSETIME INTERNATIONAL PTE. LTD., Singapore (SG)

(72) Inventors: Maoqing TIAN, Singapore (SG); Yimin JIANG, Singapore (SG); Shuai YI, Singapore (SG)

(21) Appl. No.: 17/348,052

(22) Filed: Jun. 15, 2021

Related U.S. Application Data
(63) Continuation of application No. PCT/IB2021/053490, filed on Apr. 28, 2021.

(30) Foreign Application Priority Data
Dec. 28, 2020 (SG) 10202013080R

(51) Int. Cl. G06K 9/00; G06K 9/62

(52) U.S. Cl. CPC G06K 9/00201; G06K 9/6262; G06K 9/6256

(57) ABSTRACT

Image identification methods and apparatuses, image generation methods and apparatuses, and neural network training methods and apparatuses are provided. In one aspect, an image identification method includes: obtaining a first image including a physical stack formed by stacking one or more first physical objects, and obtaining, by inputting the first image to a first neural network, category information of each of the one or more first physical objects output by the first neural network. The first neural network is pre-trained with a second image generated based on a virtual stack that is generated by stacking a three-dimensional model of one or more second physical objects.

### CROSS-REFERENCE TO RELATED APPLICATIONS

The present disclosure is a continuation application of International Application No. PCT/IB2021/053490 filed on Apr. 28, 2021, which claims a priority of the Singaporean patent application No. 10202013080R filed on Dec. 28, 2020, all of which are incorporated herein by reference in their entireties.

### TECHNICAL FIELD

The present disclosure relates to the field of computer vision technology, and in particular, to image identification methods and apparatuses, image generation methods and apparatuses, and neural network training methods and apparatuses.

### BACKGROUND

Object identification has important applications in actual production and life. For example, stacked products need to be identified on a production line, a transportation line, and a sorting line. A common object identification method is implemented based on a trained convolutional neural network, and in the process of training a convolutional neural network, a large number of two-dimensional images of physical objects with annotations are required as sample data.

### SUMMARY

Embodiments of the present disclosure provide image identification methods and apparatuses, image generation methods and apparatuses, and neural network training methods and apparatuses.

According to a first aspect of embodiments of the present disclosure, an image identification method is provided, which includes: obtaining a first image including a physical stack formed by stacking one or more first physical objects; and obtaining, by inputting the first image to a first neural network pre-trained, category information of each of the one or more first physical objects output by the first neural network, where the first neural network is trained with a second image generated based on a virtual stack, and the virtual stack is generated by stacking a three-dimensional model of at least one second physical object.

According to a second aspect of embodiments of the present disclosure, an image generation method is provided, which includes: obtaining three-dimensional models and category information of one or more objects, where the three-dimensional models of the one or more objects are generated based on a two-dimensional image of the one or more objects; stacking a plurality of the three-dimensional models to obtain a virtual stack; converting the virtual stack into a two-dimensional image of the virtual stack; and generating category information of the two-dimensional image of the virtual stack based on category information of multiple virtual objects in the virtual stack.

According to a third aspect of embodiments of the present disclosure, a method of training a neural network is provided, which includes: obtaining an image generated by the image generation method of any one of embodiments of the present disclosure as a sample image; and training a first neural network with the sample image, the first neural network being configured to identify category information of each physical object in a physical stack.

According to a fourth aspect of embodiments of the present disclosure, an image identification apparatus is provided, which includes: a first obtaining module, configured to obtain a first image including a physical stack formed by stacking one or more first physical objects; and an inputting module, configured to obtain, by inputting the first image to a first neural network pre-trained, category information of each of the one or more first physical objects output by the first neural network, where the first neural network is trained with a second image generated based on a virtual stack, and the virtual stack is generated by stacking a three-dimensional model of at least one second physical object.

According to a fifth aspect of embodiments of the present disclosure, an image generation apparatus is provided, which includes: a second obtaining module, configured to obtain three-dimensional models and category information of one or more objects, where the three-dimensional models of the one or more objects are generated based on a two-dimensional image of the one or more objects; a first stacking module, configured to stack a plurality of the three-dimensional models to obtain a virtual stack; a converting module, configured to convert the virtual stack into a two-dimensional image of the virtual stack; and a generating module, configured to generate category information of the two-dimensional image of the virtual stack based on category information of multiple virtual objects in the virtual stack.

According to a sixth aspect of embodiments of the present disclosure, an apparatus for training a neural network is provided, which includes: a third obtaining module, configured to obtain an image generated by the image generation apparatus of any one of embodiments of the present disclosure as a sample image; and a training module, configured to train a first neural network with the sample image, the first neural network being configured to identify category information of each physical object in a physical stack.

According to a seventh aspect of embodiments of the present disclosure, a computer readable storage medium is provided. The computer readable storage medium stores a computer program, and when the computer program is executed by a processor, the method according to any one of the embodiments is implemented.

According to an eighth aspect of embodiments of the present disclosure, a computer device is provided, which includes a memory, a processor and a computer program stored in the memory and executable on the processor, where when the processor executes the computer program, the method according to any one of the embodiments is implemented.

According to a ninth aspect of embodiments of the present disclosure, a computer program stored in a storage medium is provided. When the computer program is executed by a processor, the method according to any one of the embodiments is implemented.

In embodiments of the present disclosure, the first neural network is used to obtain category information of the physical object in the physical stack. In the process of training the first neural network, the first neural network is trained with the second image generated based on the virtual stack, instead of the image of the physical objects. Since the acquisition difficulty of the sample image of the physical stack is relatively high, with the method according to embodiments of the present disclosure, batch generation of sample images of the virtual stack is implemented and the first neural network is trained with the sample images of the virtual stack, which reduces the number of needed samples for the physical stack. Thus, the acquisition difficulty of the sample images for training the first neural network is reduced and the cost for training the first neural network is reduced.

It should be understood that the above general description and the following detailed description are merely exemplary and explanatory and are not limiting of the present disclosure.

### BRIEF DESCRIPTION OF THE DRAWINGS

The accompanying drawings herein are incorporated in and constitute a part of this description, and these accompanying drawings illustrate embodiments consistent with the present disclosure and together with the description serve to explain the technical solutions of the present disclosure.

FIG. 1 is a schematic flowchart of an image identification method according to an embodiment of the present disclosure.

FIGS. 2A and 2B are schematic diagrams of a stacking manner of objects, respectively.

FIG. 3 is a schematic flowchart of generating a second image according to an embodiment of the present disclosure.

FIGS. 4A and 4B are schematic diagrams of a network parameter migration process according to an embodiment of the present disclosure.

FIG. 5 is a schematic flowchart of an image generation method according to an embodiment of the present disclosure.

FIG. 6 is a flowchart of a method of training a neural network according to an embodiment of the present disclosure.

FIG. 7 is a schematic block diagram of an image identification apparatus according to an embodiment of the present disclosure.

FIG. 8 is a schematic block diagram of an image generation apparatus according to an embodiment of the present disclosure.

FIG. 9 is a schematic block diagram of an apparatus of training a neural network according to an embodiment of the present disclosure.

FIG. 10 is a schematic structural diagram of a computer device according to an embodiment of the present disclosure.

### DETAILED DESCRIPTION OF THE EMBODIMENTS

Exemplary embodiments will be described in detail herein, examples of which are shown in the accompanying drawings. The following description relates to the drawings, unless otherwise indicated, the same numerals in the different drawings represent the same or similar elements. The embodiments described in the following exemplary embodiments do not represent all embodiments consistent with the present disclosure. Rather, they are merely examples of apparatuses and methods consistent with some aspects of the present disclosure as detailed in the appended claims.

Terms used in the present disclosure are for the purpose of describing particular embodiments only and are not intended to limit the present disclosure. The singular form “a/an”, “said”, and “the” used in the present disclosure and the attached claims are also intended to include the plural form, unless other meanings are clearly represented in the context. It should also be understood that the term “and/or” used herein refers to and includes any or all possible combinations of one or more associated listed terms. In addition, the term “at least one” herein represents any one of multiple types or any combination of at least two of multiple types.

It should be understood that although the present disclosure may use the terms such as first, second, and third to describe various information, the information should not be limited to these terms. These terms are only used to distinguish the same type of information from one another. For example, in the case of not departing from the scope of the present disclosure, first information may also be referred to as second information; similarly, the second information may also be referred to as the first information. Depending on the context, for example, the word “if” used herein may be interpreted as “upon” or “when” or “in response to determining”.

To make a person skilled in the art better understand the technical solutions in the embodiments of the present disclosure, and to enable the aforementioned purposes, features, and advantages of the embodiments of the present disclosure to be more obvious and understandable, the technical solutions in the embodiments of the present disclosure are further explained in detail below by combining the accompanying drawings.

FIG. 1 is a schematic flowchart of an image identification method according to an embodiment of the present disclosure. As shown in FIG. 1, the method may include steps 101 to 102.

At step 101, a first image is obtained, where the first image includes a physical stack formed by stacking one or more first physical objects.

At step 102, the first image is input into a first neural network pre-trained to obtain category information of each of the one or more first physical objects output by the first neural network.

The first neural network is trained with a second image. The second image is generated based on a virtual stack. The virtual stack is generated by stacking a three-dimensional model of at least one second physical object. In embodiments of the present disclosure, the category information of the first physical objects and the category information of the second physical objects may be the same or different. Taking that the first physical objects and the second physical objects are both sheet-like game coins and the category information represents a value of the game coin as an example, the first physical objects may include game coins having value of 1 dollar and 0.5 dollar, and the second physical objects may include game coins having a value of 5 dollars.

In embodiments of the present disclosure, the first neural network is used to obtain category information of the physical object in the physical stack. The physical object is a tangible and visible entity. In the process of training the first neural network, the first neural network is trained with the second image generated based on the virtual stack, instead of the image of the physical stack. Since the acquisition difficulty of the sample image of the physical stack is relatively high and the acquisition difficulty of the sample image of the virtual stack is relatively low, with the method according to embodiments of the present disclosure, batch generation of sample images of the virtual stack is implemented and the first neural network is trained with the sample images of the virtual stack, which reduces the number of needed samples for the physical stack. Thus, the acquisition difficulty of the sample images for training the first neural network is reduced and the cost for training the first neural network is reduced.

At step 101, the physical stack may be placed on a flat surface (such as, a top of a table). The first image may be captured by an image acquisition apparatus disposed around the flat surface and/or above the flat surface. Further, image segmentation processing may also be performed on the first image to remove a background region from the first image, thereby improving subsequent processing efficiency.

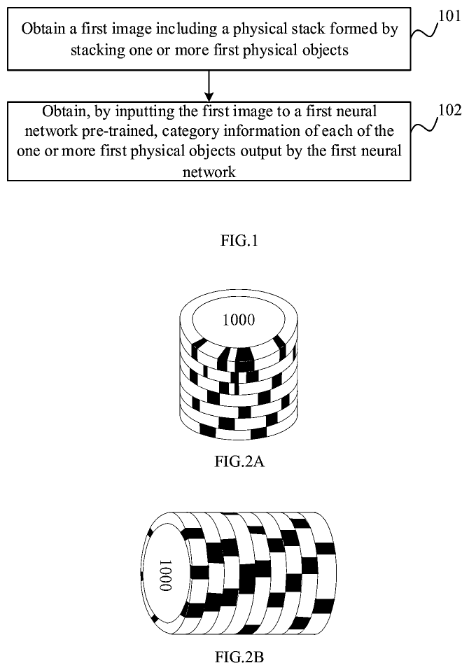

In embodiments of the present disclosure, a physical object may also be referred to as an object. The number of physical objects in the physical stack included in the first image may be one or more, and the number of objects is not determined in advance. The shape and dimension of each object in the physical stack may be the same or similar, for example, a cylindrical object having a diameter of about 5 centimeters or a cube object having each side length of about 5 centimeters, but the present disclosure is not limited thereto. In the case where there are a plurality of objects, the plurality of objects may be stacked along a stacking direction, for example, the plurality of objects may be stacked along a vertical direction in the manner shown in FIG. 2A, or the plurality of objects may be stacked along a horizontal direction in the manner shown in FIG. 2B. It should be noted that, in practical application, the plurality of objects stacked are not required to be strictly aligned, and each object may be stacked in a relatively random manner, for example, an edge of each object may be not aligned.

At step 102, the category information of each object in the physical stack may be identified with the first neural network pre-trained. According to actual needs, category information of objects at one or more locations in the physical stack may be identified. Alternatively, objects for one or more categories may be identified from the physical stack. Alternatively, the category information of all objects in the physical stack may be identified. Here, the category information of the object represents a category to which the object belongs under a category dimension, for example, color, size, value, or other preset dimension. In some embodiments, the first neural network may further output one or more of the number of objects, stack height information of objects, location information of objects, etc. For example, the number of objects for one or more categories in the physical stack may be determined based on the identification result. The identification result may be a sequence. A length of the sequence is associated with the number of objects in the physical stack. Table 1 shows the identification result of the first neural network in which objects belonging to three categories A, B and C are identified, for example, the number of objects belonging to category A is 3, the color is red, and the positions where the objects belonging to category A are located are position 1, position 2 and position 4 in the physical stack. In the case shown in Table 1, the sequence output by the first neural network may be in the form of {A, 3, red, (1,2,4); B, 2, yellow, (5,9); C, 5, purple, (3,6,7,8,10)}.

TABLE 1
the identification result of the first neural network

| Category | Number | Color | Position |
|---|---|---|---|
| A | 3 | Red | 1, 2, 4 |
| B | 2 | Yellow | 5, 9 |
| C | 5 | Purple | 3, 6, 7, 8, 10 |

In some embodiments, the method further includes: obtaining a plurality of three-dimensional models for the at least one second physical object, and stacking the plurality of the three-dimensional models to obtain the virtual stack. The stacking of physical objects can be simulated with the above manner, and the first neural network can be trained with the second image generated based on the virtual stack, instead of the image of the physical objects.

Optionally, the plurality of three-dimensional models may include a plurality of three-dimensional models of objects for different categories. For example, a three-dimensional model M1 of an object for category 1, a three-dimensional model M2 of an object for category 2, . . . , and a three-dimensional model Mn of an object for category n can be included. Optionally, the plurality of three-dimensional models can also include a plurality of three-dimensional models of objects for the same category. For example, a three-dimensional model M1 of object O1 for category 1, a three-dimensional model M2 of object O2 for category 1, . . . , and a three-dimensional model Mn of object On for category 1 can be included. The object O1 for category 1, object O2 for category 1, . . . , and object On for category 1 may be the same object, or different objects for the same category. The n is a positive integer. Optionally, the plurality of three-dimensional models may include a plurality of three-dimensional models of objects for different categories and a plurality of three-dimensional models of objects for the same category. To simulate the stacking of objects in actual scenes as much as possible, when stacking the plurality of three-dimensional models, each three-dimensional model may be stacked in a relatively random manner, that is, the edges of each three-dimensional model may not be aligned.

In the case that the plurality of three-dimensional models include a plurality of three-dimensional models of objects for the same category, a three-dimensional model of at least one object belonging to the category may be copied, and the copied three-dimensional model is translated (i.e., moved parallelly) and/or rotated to obtain the plurality of three-dimensional models. In this way, the plurality of three-dimensional models can be obtained based on the three-dimensional model of at least one object belonging to the category, the number of three-dimensional models is increased, and the complexity of obtaining the plurality of three-dimensional models is reduced. The categories of the respective three-dimensional models obtained by copying a same to-be-copied three-dimensional model are the same as the category of the to-be-copied three-dimensional model. The rotation and translation operations do not change the category of the three-dimensional model. Therefore, the category corresponding to the copied three-dimensional model can be directly annotated as the category of the object corresponding to the to-be-copied three-dimensional model, so that the three-dimensional model containing object category annotation information can be quickly obtained, thereby improving the annotation efficiency, and further improving the efficiency of training the first neural network.

In the case where at least one second physical object includes objects for multiple categories, for each of the multiple categories, at least one target physical object of the at least one second physical object belonging to the category is determined and a three-dimensional model of one of the at least one target physical object is copied. For example, a three-dimensional model of an object for category 1 may be copied to obtain c1 three-dimensional models of category 1, and a three-dimensional model of an object for category 2 may be copied to obtain c2 three-dimensional models of category 2, and so on, where c1 and c2 are positive integers. The three-dimensional models for the respective categories obtained by copying may be randomly stacked to obtain a plurality of virtual stacks, so that the obtained virtual stacks include three-dimensional models with different numbers and category distribution, thereby simulating the number of objects and object distribution in the actual scenes as much as possible. Multiple different second images for training the first neural network may further be generated based on different virtual stacks, thereby improving the accuracy of the trained first neural network. For example, virtual stack S1 for generating the second image I1 is formed by stacking one three-dimensional model for category 1 and two three-dimensional models for category 2, and virtual stack S2 for generating the second image I2 is formed by stacking three three-dimensional models for category 3, etc.

A three-dimensional model of an object may be drawn with a three-dimensional model drawing software, or may also be obtained by performing three-dimensional reconstruction on a plurality of two-dimensional images of an object. Specifically, a plurality of two-dimensional images of an object at different viewing angles may be obtained. The plurality of two-dimensional images include images of each surface of the object. For example, in a case where the object is a cubic shape, images of six lateral surfaces of the object may be obtained. For another example, in a case where the object is in a cylindrical shape, images of the upper and lower surfaces of the object and an image of the lateral surface may be obtained. When three-dimensional reconstruction is performed on the plurality of two-dimensional images of the object, edge segmentation may be performed on each of the plurality of two-dimensional images of the object to remove a background region in the two-dimensional image. Then, the three-dimensional model is reconstructed by performing processing such as rotation and splicing on the two-dimensional images. The manner for obtaining the three-dimensional model with three-dimensional reconstruction has a relatively low complexity, so that the efficiency of obtaining the three-dimensional model can be improved, the efficiency of training the first neural network can be improved, and the computing resource consumption in the training process can be reduced.

After obtaining the virtual stack, the virtual stack may further be preprocessed, so that the virtual stack is closer to the physical stack, thereby improving the accuracy of the trained first neural network. Optionally, the pre-processing includes rendering the virtual stack. By the rendering process, the color and/or texture of the virtual stack may be closer to the physical stack. The rendering process may be implemented by a rendering algorithm in a rendering engine, and the present disclosure does not limit the type of the rendering algorithm. The rendering result obtained by the rendering process may be a virtual stack or a two-dimensional image of the virtual stack.

Optionally, the pre-processing may further include performing style conversion (also referred to as style transfer) on the rendering result, that is, the rendering result is converted into a style close to the physical stack. For example, a highlight part in the rendering result is processed, or a shadow effect is added to the rendering result, so that the style of the rendering result is closer to the style of the objects captured in the actual scene. Through the above processing, conditions such as illumination in the real scene can be simulated, and the accuracy of the trained first neural network can be improved. The style conversion can be implemented by using a second neural network. It should be noted that the style conversion may be performed after the rendering process, or may be performed before the rendering process, that is, style transfer is performed on the virtual stack or the two-dimensional image of the virtual stack, and then the rendering process is performed on the style transfer result.

Taking performing the rendering process first and then performing style migration as an example, the rendering result and the third image may be input to a second neural network to obtain the second image with the same style as the third image, where the third image includes a physical stack formed by stacking physical objects. Therefore, the rendering result can be converted to the same style as the real scene based on the third image, where the third image is generated based on the objects in the real scene. This implementation is simple.

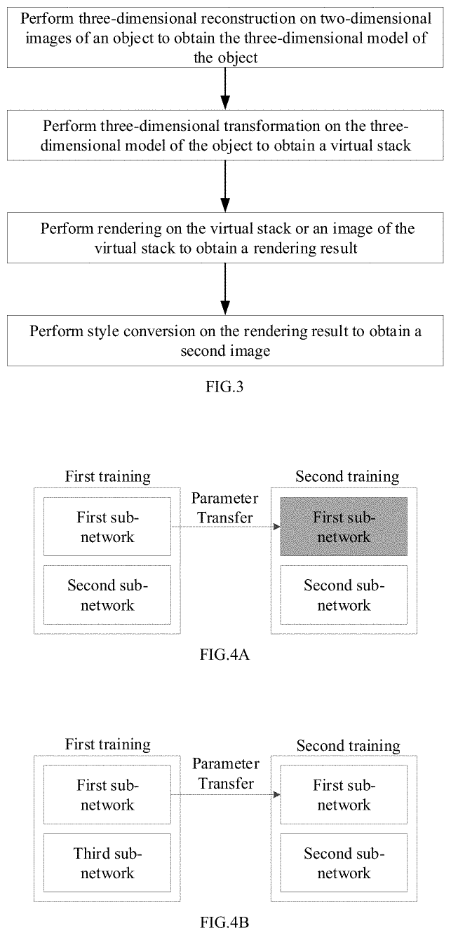

In some embodiments, the second image may be generated with the manner shown in FIG. 3. As shown in FIG. 3, a three-dimensional model of an object is obtained by performing three-dimensional reconstruction on an image of the object, then three-dimensional transformation (such as, copying, rotating, translating, etc.) is performed on the three-dimensional model of the object to obtain a virtual stack, then rendering is performed on the virtual stack or an image generated by the virtual stack, style conversion is performed on the rendering result, and finally a second image is obtained. It should be noted that one or more steps in the foregoing embodiments may be omitted according to actual needs, and the order of execution between each step may also be adjusted, for example, the order of rendering and style conversion may be adjusted.

In some embodiments, the first neural network includes a first sub-network and a second sub-network, the first sub-network is used for extracting features from the first image, and the second sub-network is used for predicting category information of the object based on the features. The first sub-network may be a convolutional neural network (CNN), and the second sub-network may be a model which can obtain output results of indefinite length according to features of fixed length. The model may be a CTC (Connectionist Temporal Classification) classifier, a recurrent neural network, or an attention model, and the like. In this way, the classification result can be accurately output in an application scene where the number of objects in the physical stack is unfixed.

To improve the accuracy of the trained first neural network, the first neural network can be trained based on both of images of the physical stack and images of the virtual stack. In this way, the error due to the difference between the image of the virtual stack and the image of the physical stack can be corrected, and the accuracy of the trained first neural network can be improved. As shown in FIG. 4A, first training can be performed on the first sub-network and the second sub-network based on the second image, and second training can be performed on the second sub-network after the first training based on a fourth image, where the fourth image includes a physical stack formed by stacking physical objects. In the second training process, network parameter values of the first sub-network can be kept constant, and only network parameter values of the second sub-network can be adjusted.

Or as shown in FIG. 4B, first training can be performed on the first sub-network and a third sub-network based on the second image, where the first sub-network and the third sub-network are configured to form a third neural network, and the third neural network is configured to classify objects in the second image; performing second training on the second sub-network and the first sub-network after the first training based on a fourth image, where the fourth image includes a physical stack formed by stacking physical objects.

In some embodiments, the type and structure of the second sub-network and the third sub-network may be the same or different. For example, the second sub-network is a CTC classifier, and the third sub-network is a recurrent neural network. Or the second sub-network and the third sub-network are both CTC classifiers.

In the training manner shown in FIG. 4B, since the network parameter values of the first sub-network obtained by the first training is taken as the initial parameter values of the first sub-network in the second training process, the training of the first sub-network and the training of the second sub-network in the second training process may be not synchronized. To solve the above problem, during the second training process, the network parameter values of the first sub-network may be kept fixed first, only the second sub-network is trained, and when the training of the second sub-network satisfies a preset condition, the first sub-network and the second sub-network are trained jointly. The preset condition may be that the number of times of training reaches a preset number of times, an output error of the first neural network is less than a preset error, or may also be another condition.

In the foregoing embodiments, the first neural network is trained in a parameter transfer manner, that is, the first neural network is pre-trained (first training) based on an image of a virtual stack, and then by taking the network parameter values obtained by pre-training as initial parameter values, the first neural network is second trained (second training) with a fourth image. In this way, the error due to the difference between the image of the virtual stack and the image of the physical stack is corrected, and the accuracy of the trained first neural network is improved.

Since the first neural network first performs pre-training through the image of the virtual stack, only a small number of images of physical stacks are needed to perform parameter value fine adjustment on the first neural network during the second training, thereby further optimizing the parameter values of the first neural network. Compared with the manner in which images of the physical objects are directly used to train the first neural network, the embodiments of the present disclosure, on the one hand, can significantly reduce the number of images of the physical objects required in the training process, and on the other hand, can improve the identification accuracy of the trained first neural network.

The objects may include sheet-like objects, and a stacking direction of the physical stack and a stacking direction of the virtual stack are a thickness direction of the sheet-like objects. In practical scenes, since the stacking of the sheet-like objects in the stacking direction (thickness direction) is relatively close, and the difficulty of dividing the stacked sheet-like objects into a single sheet-like object with an image segmentation method is relatively large, when the trained neural network is used to process an image of a stack, the identification accuracy and the identification efficiency can be improved. However, since the image information of the stack formed by stacking sheet-like objects is not easily collected, this problem is solved by the method provided by the foregoing embodiments of the present disclosure. In embodiments of the present disclosure, a large number of images of the virtual stack can be obtained to train the neural network, thereby improving the identification efficiency and accuracy of the stacked sheet-like objects.

Hereinafter, a specific scene is taken as an example to describe a solution provided by embodiments of the present disclosure. In a game scene, each player has game coins, and the game coin may be a cylindrical thin sheet. First, two-dimensional images of virtual stacks formed by stacking three-dimensional models of mass game coins are used to train the first neural network in a first stage. The first neural network includes two parts: a CNN and a CTC, the CNN part uses a convolutional neural network to extract features of an image, and the CTC classifier converts the features output by the CNN into sequence prediction results of indefinite lengths. Then, images of physical stacks formed by stacking physical objects are used to train the first neural network in a second stage. In the process of training the first neural network in the second stage, the parameter values of the CNN trained in the first stage may be kept unchanged, and only the parameter values of the CTC trained in the first stage may be adjusted, and the first neural network after the second training may be used for identifying game coins.

In some scenes, the object to generate the three-dimensional model and the object in the first image may have different categories. In this way, the two objects have different sizes, shapes, colors and/or textures, etc. For example, the object in the first image is a coin whose value is 1 dollar, and the object for generating the three-dimensional model is a coin whose value is five cents. In this case, category information of the object in the first image output by the first neural network is incorrect. Thus, in embodiments of the present disclosure, the image identification method further includes: determining a performance of the first neural network based on category information of the object in the first image output by the first neural network; in response to determining that the performance of the first neural network does not satisfy a pre-determined condition, a smaller number of fifth images can be used to correct the network parameter values of the trained first neural network. The fifth image includes an image of a physical stack formed by stacking the coins whose values are 1 dollar, and then the physical object in the first image is identified based on the corrected first neural network. In embodiments of the present disclosure, the performance of the first neural network can be estimated based on an prediction error for object category information of the first neural network. The pre-determined condition can be a prediction error threshold. When the prediction error for object category information of the first neural network is greater than the prediction error threshold, it is determined that the performance of the first neural network does not satisfy the pre-determined condition. When determining that the performance of the first neural network does not satisfy the pre-determined condition, a first image in which the prediction category is incorrect can be used as a fifth image to fine-tune the first neural network. Through the above method, the cross-data transfer training method is implemented, which solves the problem of data difference caused when fusing different data sets for training, and further improves the identification accuracy of the first neural network.

The image identification method provided by embodiments of the present disclosure reduces manual participation during sample data collection and greatly improves the generation efficiency of sample data. There are many problems in the existing sample data collection and annotation/labeling process. The problems include:

(1) training the first neural network requires a large amount of sample data, and in actual scenes, the speed of collecting the sample data is relatively slow and the workload is relatively large;

(2) the collected sample data needs to be manually labelled. In many cases, the categories of sample data are vast and partial sample data is very similar. Thus, the manual labeling speed is slow and the labeling accuracy is not high;

(3) in a real environment, external factors such as lighting vary greatly, and sample data in different scenes needs to be collected, thereby further increasing the difficulty and workload of data collection;

(4) for the needs of data privacy and data security, some sample objects are difficult to acquire in a real environment;

(5) in the stack identification scene, the acquisition difficulty of the sample images of the physical stacks is relatively high. The image information of the physical stacks is not easily collected due to the thinner thickness and the larger number of the physical objects.

In embodiments of the present disclosure, the first neural network is trained with the second images generated based on virtual stacks, instead of images of physical objects. Because the acquisition difficulty of sample images of virtual stacks is relatively low, based on the methods of embodiments of the present disclosure, the number of needed samples of the physical stacks is reduced, thereby reducing the acquisition difficulty of the sample images for training the first neural network and the cost for training the first neural network. Different three-dimensional models may be generated based on models of the physical objects, and the generated three-dimensional models do not need to be manually labeled, thereby further improving training efficiency of the first neural network, and meanwhile improving accuracy of sample data. By rendering, style conversion, and the like, the conditions such as illumination in real environment can be simulated as much as possible with collecting a small amount of sample data in real scenes, thereby reducing the difficulty of collecting sample data.

As shown in FIG. 5, embodiments of the present disclosure further provide an image generation method including steps 501-504.

At step 501, three-dimensional models and category information of one or more objects are obtained, where the three-dimensional models of the one or more objects are generated based on a two-dimensional image of the one or more objects.

At step 502, a plurality of the three-dimensional models are stacked to obtain a virtual stack.

At step 503, the virtual stack is converted into a two-dimensional image of the virtual stack.

At step 504, category information of the two-dimensional image of the virtual stack is generated based on category information of multiple virtual objects in the virtual stack.

In some embodiments, the method further includes: copying the three-dimensional model of at least one of the one or more objects; and obtaining, by performing translation and/or rotation on the copied three-dimensional model, the plurality of the three-dimensional models.

In some embodiments, the one or more objects belong to a plurality of categories; copying the three-dimensional model of at least one of the one or more objects includes: for each of the plurality of categories, determining at least one target object of the one or more objects that belongs to the category; and copying the three-dimensional model of one of the at least one target object.

In some embodiments, the method further includes: obtaining multiple two-dimensional images of the one of the at least one target object; and obtaining the three-dimensional model of the one of the at least one target object by performing three-dimensional reconstruction on the multiple two-dimensional images.

In some embodiments, the method further includes: after obtaining the virtual stack, performing rendering process on a three-dimensional model of the virtual stack to obtain a rendering result; and generating the two-dimensional image of the virtual stack by performing style transfer on the rendering result.

In some embodiments, the one or more objects include one or more sheet-like objects; stacking a plurality of the three-dimensional models includes: stacking, along a thickness direction of the one or more sheet-like objects, the plurality of the three-dimensional models.

For details of the method embodiments, reference may be made to the foregoing embodiments of the image identification method, and details are not described herein again.

As shown in FIG. 6, embodiments of the present disclosure further provide a method of training a neural network. The method includes steps 601-602.

At step 601, a sample image is obtained.

At step 602, a first neural network is trained with the sample image, the first neural network being configured to identify category information of each physical object in a physical stack.

The sample image obtained at step 601 may be generated based on the image generation method provided by any of the embodiments of the present disclosure. That is, an image generated with the image generation method provided by any of the embodiments of the present disclosure can be obtained as a sample image.

In some embodiments, the sample image further includes annotation information, which is used to represent category information of the three-dimensional model in the virtual stack in the sample image. Category information of a three-dimensional model is the same as the category of the physical object that generates the three-dimensional model. If a plurality of three-dimensional models is obtained by performing at least one of copying, rotating and translating on a three-dimensional model, the categories of the plurality of three-dimensional models are the same as the three-dimensional model.

For details of the method embodiments, reference may be made to the foregoing embodiments of the image identification method, and details are not described herein again.

It can be understood by those skilled in the art that, in the methods of the detailed description, the drafting order of each step does not mean the strictly executed order and does not form any limitation to the implementation process, and the specific execution order of each step should be determined by its function and possibly intrinsic logic.

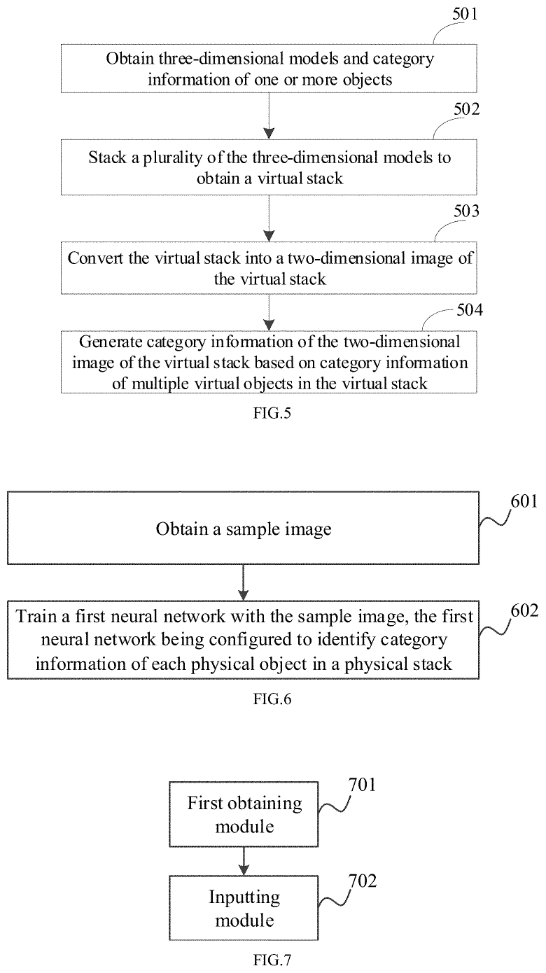

As shown in FIG. 7, embodiments of the present disclosure further provide an image identification apparatus including:

a first obtaining module 701, configured to obtain a first image including a physical stack formed by stacking one or more first physical objects;

an inputting module 702, configured to obtain, by inputting the first image to a first neural network pre-trained, category information of each of the one or more first physical objects output by the first neural network.

The first neural network is trained with a second image generated based on a virtual stack, and the virtual stack is generated by stacking a three-dimensional model of at least one second physical object.

In some embodiments, the apparatus further includes: a fourth obtaining module, configured to obtain a plurality of three-dimensional models for the at least one second physical object; and a stacking module, configured to perform spatial stacking on the plurality of the three-dimensional models to obtain the virtual stack.

In some embodiments, the fourth obtaining module includes: a copying unit, configured to copy a three-dimensional model of one or more of the at least one second physical object; and a translating-rotating unit, configured to obtain, by performing translation and/or rotation on the copied three-dimensional model, the plurality of the three-dimensional models for the at least one second physical object.

In some embodiments, the at least one second physical object belongs to a plurality of categories; the copying unit is configured to: for each of the plurality of categories, determine at least one target physical object of the at least one second physical object that belongs to the category; and copy a three-dimensional model of one of the at least one target physical object.

In some embodiments, the apparatus further includes: a fifth obtaining module, configured to obtain multiple two-dimensional images of the one of the at least one target physical object; and a first three-dimensional reconstruction module, configured to obtain the three-dimensional model of the one of the at least one target physical object by performing three-dimensional reconstruction on the multiple two-dimensional images.

In some embodiments, the apparatus further includes: a first rendering module, configured to: after obtaining the virtual stack, perform rendering process on the virtual stack to obtain a rendering result; and a first style transfer module, configured to generate the second image by performing style transfer on the rendering result.

In some embodiments, the first style transfer module is configured to: input the rendering result and a third image to a second neural network to obtain the second image with the same style as the third image, where the third image includes a physical stack formed by stacking the at least one second physical object.

In some embodiments, the first neural network includes a first sub-network for extracting a feature from the first image and a second sub-network for predicting category information of each of the at least one second physical object based on the feature.

In some embodiments, the first neural network is trained by the following modules including: a first training module, configured to perform first training on the first sub-network and the second sub-network based on the second image; and a second training module, configured to perform, based on a fourth image, second training on the second sub-network after the first training, where the fourth image includes a physical stack formed by stacking the at least one second physical object. Or, the first neural network is trained by the following modules including: a first training module, configured to perform first training on the first sub-network and a third sub-network based on the second image; where the first sub-network and the third sub-network are configured to form a third neural network, and the third neural network is configured to classify objects in the second image; and a second training module, configured to perform, based on a fourth image, second training on the second sub-network and the first sub-network after the first training, where the fourth image includes a physical stack formed by stacking the at least one second physical object.

In some embodiments, the apparatus further includes a correcting module, configured to determine a performance of the first neural network based on category information of each of the one or more first physical objects output by the first neural network; and in response to determining that the performance of the first neural network does not satisfy a pre-determined condition, correct network parameter values of the first neural network based on a fifth image, where the fifth image includes a physical stack formed by stacking one or more first physical objects.

In some embodiments, the one or more first physical objects include one or more first sheet-like objects, the at least one second physical object includes at least one second sheet-like object, a stacking direction of the physical stack is a thickness direction of the one or more first sheet-like objects, and a stacking direction of the virtual stack is a thickness direction of the at least one second sheet-like object.

As shown in FIG. 8, embodiments of the present disclosure further provide an image generation apparatus including:

a second obtaining module 801, configured to obtain three-dimensional models and category information of one or more objects, where the three-dimensional models of the one or more objects are generated based on a two-dimensional image of the one or more objects;

a first stacking module 802, configured to stack a plurality of the three-dimensional models to obtain a virtual stack;

a converting module 803, configured to convert the virtual stack into a two-dimensional image of the virtual stack;

a generating module 804, configured to generate category information of the two-dimensional image of the virtual stack based on category information of multiple virtual objects in the virtual stack.

In some embodiments, the apparatus further includes: a copying module, configured to copy the three-dimensional model of at least one of the one or more objects; and a translating-rotating module, configured to obtain, by performing translation and/or rotation on the copied three-dimensional model, the plurality of the three-dimensional models.

In some embodiments, the one or more objects belong to a plurality of categories; the copying module is configured to: for each of the plurality of categories, determine at least one target object of the one or more objects that belongs to the category; and copy the three-dimensional model of one of the at least one target object.

In some embodiments, the apparatus further includes: a sixth obtaining module, configured to obtain multiple two-dimensional images of the one of the at least one target object; and a second three-dimensional reconstruction module, configured to obtain the three-dimensional model of the one of the at least one target object by performing three-dimensional reconstruction on the multiple two-dimensional images.

In some embodiments, the apparatus further includes: a second rendering module, configured to: after obtaining the virtual stack, perform rendering process on a three-dimensional model of the virtual stack to obtain a rendering result; and a second style transfer module, configured to generate the two-dimensional image of the virtual stack by performing style transfer on the rendering result.

In some embodiments, the one or more objects include one or more sheet-like objects; the first stacking module is configured to stack, along a thickness direction of the one or more sheet-like objects, the plurality of the three-dimensional models.

As shown in FIG. 9, embodiments of the present disclosure further provide an apparatus for training a neural network including:

a third obtaining module 901, configured to obtain an image generated by the image generation apparatus of any one of embodiments of the present disclosure as a sample image;

a training module 902, configured to train a first neural network with the sample image, the first neural network being configured to identify category information of each physical object in a physical stack.

In some embodiments, the functions or the modules of the apparatus provided by the embodiments of the present disclosure may be configured to execute the methods described in the foregoing method embodiments. For specific implementation, reference may be made to the description of the foregoing method embodiments. For brevity, details are not described herein again.

Embodiments of the present disclosure further provide a computer device, which includes at least a memory, a processor and a computer program stored in the memory and executable on the processor, where when the processor executes the computer program, the method according to any one of the foregoing embodiments is implemented.

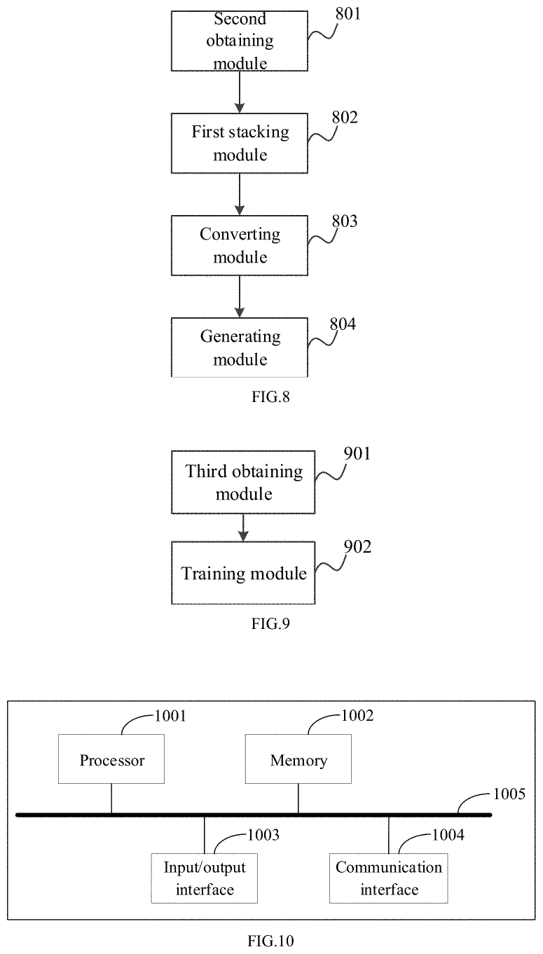

FIG. 10 shows a hardware structure diagram of a computer device provided by embodiments of the present disclosure. The device may include a processor 1001, a memory 1002, an input/output interface 1003, a communication interface 1004, and a bus 1005. The processor 1001, the memory 1002, the input/output interface 1003 and the communication interface 1004 implement communication connection between each other inside the device through the bus 1005.

The processor 1001 may be implemented by using a common CPU (Central Processing Unit), a microprocessor, an ASIC (Application Specific Integrated Circuit), or one or more integrated circuits, etc. and used to execute relevant programs to implement the technical solutions provided by the embodiments of the present description.

The memory 1002 may be implemented in the form of a ROM (Read Only Memory), a RAM (Random Access Memory), a static storage device, a dynamic storage device, and the like. The memory 1002 may store an operating system and other application programs, and when the technical solutions provided by the embodiments of the present description are implemented by software or firmware, the relevant program code is stored in the memory 1002, and the processor 1001 may invoke the relevant program code to perform the method according to any one of the foregoing embodiments.

The input/output interface 1003 is configured to connect the input/output module to implement information input and output. The input/output module (not shown in FIG. 10) may be configured in a device as a component, and may also be external to the device to provide corresponding functions. The input device may include a keyboard, a mouse, a touch screen, a microphone, various types of sensors, etc. The output device may include a display, a speaker, a vibrator, an indicator, etc.

The communication interface 1004 is configured to connect to a communication module (not shown in FIG. 10) to implement communication interaction between the present device and other devices. The communication module may implement communication in a wired manner (for example, Universal Serial Bus (USB), network wire, etc.), and may also implement communication in a wireless manner (for example, mobile network, WIFI, Bluetooth, etc.).

The bus 1005 includes a path for transmitting information between various components (such as the processor 1001, the memory 1002, the input/output interface 1003, and the communication interface 1004) of the device.

It should be noted that, although the foregoing device merely shows the processor 1001, the memory 1002, the input/output interface 1003, the communication interface 1004, and the bus 1005, in a specific implementation process, the device can further include other components necessary to implement normal operation. In addition, a person skilled in the art may understand that the above-described device may also include only components necessary for implementing the embodiments of the present description, and not necessarily all components shown in the FIG. 10.

Embodiments of the present disclosure further provide a computer readable storage medium is provided. The computer readable storage medium stores a computer program, and when the computer program is executed by a processor, the method according to any one of the foregoing embodiments is implemented.

Computer readable media include permanent and non-permanent, removable and non-removable media. Any method or technology can be used to implement information storage. The information may be computer readable instructions, data structures, modules of programs, or other data. Examples of storage media of a computer include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, Compact Disc Read-Only Memory (CD-ROM), digital versatile disc (DVD) or other optical storage, magnetic cassette, a magnetic tape disk storage or other magnetic storage device or any other non-transmission medium which can be used to store, information that can be accessed by the computer device. According to the definitions herein, the computer readable medium does not include transitory media such as a modulated data signal and carrier wave.

It can be seen from the description of the above embodiments that a person skilled in the art can clearly understand that the embodiments of the present description can be implemented by software and a necessary universal hardware platform. Based on such understanding, the technical solutions of the embodiments of the present description essentially or the part contributing to the prior art may be embodied in the form of a software product. The computer software product may be stored in a storage medium, such as a ROM/RAM, a magnetic disk, an optical disk, and the like, and include several instructions for enabling a computer device (such as a personal computer, a server, or a network device, etc.) to execute the method described in each embodiment or some part of the embodiments of the present description.

The system, apparatus, module or unit set forth in the foregoing embodiments may be specifically implemented by a computer chip or an entity, or implemented by a product having a certain function. A typical implementation device is a computer, and a specific form of the computer may be a personal computer, a laptop computer, a cellular phone, a camera phone, a smart phone, a personal digital assistant, a media player, a navigation device, an e-mail transceiver device, a game console, a tablet computer, a wearable device, or a combination of any of these devices.

Various embodiments in the present description are described in a progressive manner, and same or similar parts in the various embodiments may be referred to for each other, and each embodiment focuses on the differences from other embodiments. Especially, for the apparatus, since the apparatus embodiments is basically similar to the method embodiments, the description is simplified, and reference may be made to some of the description of the method embodiments. The apparatus embodiments described above are merely schematic, in which the modules described as separate components may or may not be physically separated, and the functions of the modules may be implemented in one or more software and/or hardware when solutions of the embodiments of the present description are implemented. Alternatively, some or all of the modules may be selected according to actual needs to implement solutions of the embodiments of the present description. A person of ordinary skill in the art would understand and implement without creative efforts.

1. An image identification method, comprising:
obtaining a first image comprising a physical stack formed by stacking one or more first physical objects; and
obtaining, by inputting the first image to a first neural network, category information of each of the one or more first physical objects output by the first neural network,
wherein the first neural network is pre-trained with a second image generated based on a virtual stack, and wherein the virtual stack is generated by stacking at least one three-dimensional model of one or more second physical objects.

2. The method according to claim 1, further comprising:
obtaining a plurality of three-dimensional models for the one or more second physical objects; and
performing spatial stacking on the plurality of three-dimensional models to obtain the virtual stack.

3. The method according to claim 2, wherein obtaining the plurality of three-dimensional models for the one or more second physical objects comprises:
copying a three-dimensional model of at least one of the one or more second physical objects; and
performing at least one of translation or rotation on the copied three-dimensional model to obtain the plurality of three-dimensional models for the one or more second physical objects.

4. The method according to claim 3, wherein the one or more second physical objects belong to a plurality of categories, and
wherein copying the three-dimensional model of the at least one of the one or more second physical objects comprises:
for each of the plurality of categories,
determining, among the one or more second physical objects, at least one target physical object that belongs to the category; and
copying a three-dimensional model of one of the at least one target physical object.

5. The method according to claim 1, further comprising:
after obtaining the virtual stack, rendering the virtual stack to obtain a rendering result; and
generating the second image by performing style transfer on the rendering result.

6. The method according to claim 5, wherein performing style transfer on the rendering result comprises:
inputting the rendering result and a third image to a second neural network to obtain the second image with a same style as the third image,
wherein the third image comprises a physical stack formed by stacking the one or more second physical objects.

7. The method according to claim 1, wherein the first neural network comprises:
a first sub-network configured to extract a feature from the first image; and
a second sub-network configured to predict category information of each of the one or more second physical objects based on the extracted feature, and
wherein the first neural network is trained by one of:
performing first training on the first sub-network and the second sub-network based on the second image; and performing, based on a fourth image, second training on the second sub-network after the first training, wherein the fourth image comprises a physical stack formed by stacking the one or more second physical objects, or
performing first training on the first sub-network and a third sub-network based on the second image, the first sub-network and the third sub-network being configured to form a third neural network that is configured to classify objects in the second image; and performing, based on a fourth image, second training on the second sub-network and the first sub-network after the first training, wherein the fourth image comprises a physical stack formed by stacking the one or more second physical objects.

8. The method according to claim 1, further comprising:
determining a performance of the first neural network based on the category information of each of the one or more first physical objects output by the first neural network; and
in response to determining that the performance of the first neural network does not satisfy a pre-determined condition, correcting network parameter values of the first neural network based on a fifth image, wherein the fifth image comprises the physical stack formed by stacking the one or more first physical objects.

9. The method according to claim 1, wherein the one or more first physical objects comprise one or more sheet-like objects, and
wherein a stacking direction of the physical stack and a stacking direction of the virtual stack are same as a thickness direction of the one or more sheet-like objects.

10. A method comprising:
obtaining a plurality of three-dimensional models and category information of one or more objects, wherein the plurality of three-dimensional models are generated based on a two-dimensional image of the one or more objects;
stacking multiple three-dimensional models of the plurality of three-dimensional models to obtain a virtual stack;
converting the virtual stack into a two-dimensional image of the virtual stack; and
generating category information of the two-dimensional image of the virtual stack based on category information of multiple virtual objects in the virtual stack.

11. The method according to claim 10, further comprising:
copying a three-dimensional model of at least one of the one or more objects; and
performing at least one of translation or rotation on the copied three-dimensional model to obtain the multiple three-dimensional models.

12. The method according to claim 11, wherein the one or more objects belong to a plurality of categories, and
wherein copying the three-dimensional model of the at least one of the one or more objects comprises:
for each of the plurality of categories,
determining, among the one or more objects, at least one target object that belongs to the category; and
copying the three-dimensional model of one of the at least one target object.

13. The method according to claim 12, further comprising:
obtaining multiple two-dimensional images of the one of the at least one target object; and
obtaining the three-dimensional model of the one of the at least one target object by performing three-dimensional reconstruction on the multiple two-dimensional images.

14. The method according to claim 10, wherein converting the virtual stack into the two-dimensional image of the virtual stack comprises:
after obtaining the virtual stack, rendering a three-dimensional model of the virtual stack to obtain a rendering result; and
generating the two-dimensional image of the virtual stack by performing style transfer on the rendering result.

15. The method according to claim 10, wherein the one or more objects comprise one or more sheet-like objects, and
wherein stacking the multiple three-dimensional models of the plurality of the three-dimensional models comprises:
stacking the multiple three-dimensional models along a thickness direction of the one or more sheet-like objects.

16. The method according to claim 10, further comprising:
training a neural network with the two-dimensional image of the virtual stack as a sample image,
wherein the neural network is configured to identify category information of each physical object in a physical stack formed by stacking one or more physical objects.

17. A computer device, comprising:
at least one processor; and
one or more memories coupled to the at least one processor and storing programming instructions for execution by the at least one processor to perform operations comprising:
obtaining a first image comprising a physical stack formed by stacking one or more first physical objects; and
obtaining, by inputting the first image to a first neural network, category information of each of the one or more first physical objects output by the first neural network,
wherein the first neural network is pre-trained with a second image generated based on a virtual stack, and wherein the virtual stack is generated by stacking at least one three-dimensional model of one or more second physical objects.

18. The computer device according to claim 17, wherein the operations further comprise:
after obtaining the virtual stack, rendering the virtual stack to obtain a rendering result; and
generating the second image by inputting the rendering result and a third image to a second neural network to obtain the second image with a same style as the third image,
wherein the third image comprises a physical stack formed by stacking the one or more second physical objects.

19. The computer device according to claim 17, wherein the operations further comprise:
determining a performance of the first neural network based on the category information of each of the one or more first physical objects output by the first neural network; and
in response to determining that the performance of the first neural network does not satisfy a pre-determined condition, correcting network parameter values of the first neural network based on a fifth image, wherein the fifth image comprises the physical stack formed by stacking the one or more first physical objects.

20. The computer device according to claim 17, wherein the first neural network comprises:
a first sub-network configured to extract a feature from the first image; and
a second sub-network configured to predict category information of each of the one or more second physical objects based on the extracted feature, and
wherein the first neural network is trained by one of:
performing first training on the first sub-network and the second sub-network based on the second image; and performing, based on a fourth image, second training on the second sub-network after the first training, wherein the fourth image comprises a physical stack formed by stacking the one or more second physical objects, or
performing first training on the first sub-network and a third sub-network based on the second image, the first sub-network and the third sub-network being configured to form a third neural network that is configured to classify objects in the second image; and performing, based on a fourth image, second training on the second sub-network and the first sub-network after the first training, wherein the fourth image comprises a physical stack formed by stacking the one or more second physical objects.
